(19) United States
(12) Patent Application Publication
(10) Pub. No.: US 2016/0342262 A1
(43) Pub. Date: Nov. 24, 2016

(54) APPARATUS AND METHOD FOR DRIVING IN-CELL TOUCH DISPLAY PANEL

(71) Applicant: Solomon Systech (Shenzhen) Limited, Shenzhen (CN)

(72) Inventors: Hongyi Qian, Shenzhen (CN); Chin Tong Thia, Shenzhen (CN); Cheung Fai Lee, Shenzhen (CN)

(73) Assignee: Solomon Systech (Shenzhen) Limited

(21) Appl. No.: 14/723,492

(22) Filed: May 28, 2015

(30) Foreign Application Priority Data
May 19, 2015 (CN) 201510258015.2

(51) Int. Cl. G06F 3/041

(52) U.S. Cl. CPC G06F 3/0416; G06F 3/0412

(57) ABSTRACT

An apparatus for driving an in-cell touch display panel includes: at least one line buffer configured to store display data; a display driver configured to receive display data from the at least one line buffer and drive a display module based on the display data; a touch controller configured to control a touch sensor to sense touching from a user; a time multiplex controller connected with the at least one line buffer, the display driver and the touch controller; and a host processor connected with the time multiplex controller and the at least one line buffer, and configured to generate display data and send the display data to the at least one line buffer. A method for driving an in-cell touch display panel is also provided.

### CROSS-REFERENCE TO RELATED APPLICATION

This application claims the benefit of Chinese patent application No. 201510258015.2, filed on May 19, 2015, which is incorporated herein by reference.

### FIELD OF THE PATENT APPLICATION

The present patent application generally relates to electronics and more specifically to an apparatus and a method for driving an in-cell touch display panel.

### BACKGROUND

In recent years, there is an increasing demand for tight integration of a display module and a touch sensor. The display module and the touch sensor form the output and input devices of a human-machine interface that is commonly used in contemporary smart phones and mobile devices. In the tightest integration, components constituting the touch sensor are manufactured inside the display module so as to achieve the ultimate slimness in smart phone and mobile devices. This tight arrangement is called in-cell touch display by the industry.

Beside slimness, integrating the touch sensor into the display module allows pure Chip-on-Glass (COG) manufacturing. COG offers low cost, high reliability and simplifies PCB design.

On the other hand, integrating touch sensor into display module generates the following consequences. In in-cell touch, the touch sensor and the display module are stacked up in close proximity. The display driving signal can interfere with the normal sensing of the touch signal if both circuitries are operating concurrently. A general solution is to separate the two operations by time multiplexing.

With time multiplexing, the hblank mode operation allows the touch sensing report rate to differ from the display driving frame rate. In a typical mobile phone application, the display frame rate is 60 Hz while the touch report rate requires 80 Hz or higher. While hblank mode driving has its advantage, it requires the Application Processor (AP) being used with the in-cell touch display to transmit the display data in multiple sessions within a frame. It is desired to have a method and an apparatus for driving an in-cell touch display panel that enables time sharing between the display driving and the touch sensing in a seamless manner so that the host processor (i.e. AP) does not need to handle any timing issue. In other words, the host processor transfers display information to the in-cell touch panel as if it is a normal display.

### SUMMARY

The present patent application is directed to an apparatus for driving an in-cell touch display panel. In one aspect, the apparatus includes: at least one line buffer configured to store display data; a display driver configured to receive display data from the at least one line buffer and drive a display module based on the display data; a touch controller configured to control a touch sensor to sense touching from a user; a time multiplex controller connected with the at least one line buffer, the display driver and the touch controller; and a host processor connected with the time multiplex controller and the at least one line buffer, and configured to generate display data and send the display data to the at least one line buffer. The time multiplex controller is configured to regulate output rate of the display data from the at least one line buffer to be faster than input rate of the display data to the at least one line buffer so that certain amount of time is saved, and to control the touch controller to execute touch sensing with the saved time.

The apparatus for driving in-cell touch display panel may include two line buffers. The line buffers may be single port buffers, to which a read access and a write access need to be done separately. The apparatus for driving in-cell touch display panel may further include an input data switch configured to direct display data from the host processor to either one of the line buffers, and an output data switch configured to direct display data from either one of the line buffers to the display driver.

While controlling one line buffer to store display data from the host processor, the time multiplex controller may be configured to transfer display data previously stored in the other line buffer to the display driver at a faster rate.

The display driver may include a sequence of shift registers, a sequence of data latches connected in parallel with the shift registers, and a plurality of DACs connected in parallel with the data latches. The line buffer may be a dual port buffer configured to access any two memory locations simultaneously. The line buffer may further include a common memory configured to store two lines of display data in two regions thereof separately. While controlling one region of the common memory to store display data from the host processor, the time multiplex controller may be configured to transfer display data previously stored in the other region of the common memory to the display driver. The apparatus for driving in-cell touch display panel may include more than two line buffer. The line buffers may be single port buffers.

The time multiplex controller may be configured to control the at least one line buffer to start to output received display data of a data segment before all of the data segment is fully received by the at least one line buffer. The apparatus for driving in-cell touch display panel may include two or more line buffers. The line buffers may be dual port buffers.

In another aspect, the present patent application provides a method for driving an in-cell touch display panel. The method includes: generating display data and sending the display data to at least one line buffer; storing the display data with the at least one line buffer; receiving display data from the at least one line buffer and driving a display module based on the display data with a display driver; regulating output rate of the display data from the at least one line buffer to be faster than input rate of the display data to the at least one line buffer and thereby so that certain amount of time is saved with a time multiplex controller; controlling a touch controller to execute touch sensing with the saved time with the time multiplex controller; and controlling a touch sensor to sense touching from a user with the touch controller.

Two line buffers may be used and the two line buffers may be single port buffers, to which a read access and a write access need to be done separately. The method for driving an in-cell touch display panel may further include while controlling one line buffer to store display data from a host processor with the time multiplex controller, transferring display data previously stored in the other line buffer to the display driver at a faster rate with the time multiplex controller.

The line buffer may be a dual port buffer configured to access any two memory locations simultaneously. The line buffer may further include a common memory configured to store two lines of display data in two regions thereof separately. The method for driving an in-cell touch display panel may further include while controlling one region of the common memory to store display data from a host processor, transferring display data previously stored in the other region of the common memory to the display driver with the time multiplex controller. More than two line buffers may be used for single port buffers and two or more line buffers are used for dual port buffers.

In yet another aspect, the present patent application provides an apparatus for driving an in-cell touch display panel. The apparatus includes: a plurality of line buffers configured to store display data; a display driver configured to receive display data from the line buffers and drive a display module based on the display data; a touch controller configured to control a touch sensor to sense touching from a user; a time multiplex controller connected with the line buffers, the display driver and the touch controller; and a host processor connected with the time multiplex controller and the line buffers, and configured to generate display data and send the display data to the line buffers. The time multiplex controller is configured to regulate output rate of the display data from the line buffers to be faster than input rate of the display data to the line buffers so that certain amount of time is saved, and to control the touch controller to execute touch sensing with the saved time. The time multiplex controller is further configured to control the line buffers to start to output received display data of a data segment before all of the data segment is fully received by the line buffers.

While controlling one line buffer to store display data from the host processor, the time multiplex controller may be configured to transfer display data previously stored in another line buffer to the display driver at a faster rate.

### BRIEF DESCRIPTIONS OF THE DRAWINGS

FIG. 1A illustrates an apparatus for driving an in-cell touch display panel in accordance with an embodiment of the present patent application.

FIG. 1B is a timing diagram illustrating a method for driving an in-cell touch display panel in accordance with an embodiment of the present patent application.

FIG. 2A illustrates an apparatus for driving an in-cell touch display panel in accordance with another embodiment of the present patent application.

FIG. 2B is a timing diagram illustrating a method for driving an in-cell touch display panel in accordance with another embodiment of the present patent application.

FIG. 3A illustrates an apparatus for driving an in-cell touch display panel in accordance with yet another embodiment of the present patent application.

FIG. 3B is a timing diagram illustrating a method for driving an in-cell touch display panel in accordance with yet another embodiment of the present patent application.

FIG. 4A illustrates an apparatus for driving an in-cell touch display panel in accordance with still another embodiment of the present patent application.

FIG. 4B is a timing diagram illustrating a method for driving an in-cell touch display panel in accordance with still another embodiment of the present patent application.

FIG. 5A illustrates an apparatus for driving an in-cell touch display panel in accordance with still another embodiment of the present patent application.

FIG. 5B is a timing diagram illustrating a method for driving an in-cell touch display panel in accordance with still another embodiment of the present patent application.

FIG. 6A illustrates an apparatus for driving an in-cell touch display panel in accordance with still another embodiment of the present patent application.

FIG. 6B is a timing diagram illustrating a method for driving an in-cell touch display panel in accordance with still another embodiment of the present patent application.

### DETAILED DESCRIPTION

Reference will now be made in detail to a preferred embodiment of the apparatus and the method for driving an in-cell touch display panel disclosed in the present patent application, examples of which are also provided in the following description. Exemplary embodiments of the apparatus and the method disclosed in the present patent application are described in detail, although it will be apparent to those skilled in the relevant art that some features that are not particularly important to an understanding of the apparatus and the method may not be shown for the sake of clarity.

Furthermore, it should be understood that the apparatus and the method disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

A segment is defined to be the display period between two consecutive touch periods. According to an embodiment of the present patent application, when data for a first segment is sent (from the AP), the display driver stores the data in line buffers. At the end of the first segment, the display driver will output the data of first segment in a faster manner. At the same time, it will store the data for the second segment into the line buffers. Due to the faster output speed, certain amount of time will be saved and that will be used for touch sensing. At the end of the second segment, the display driver will output the data of second segment in a faster manner. At the same time, it will store the data for the third segment. This process will repeat until the end of the frame is processed.

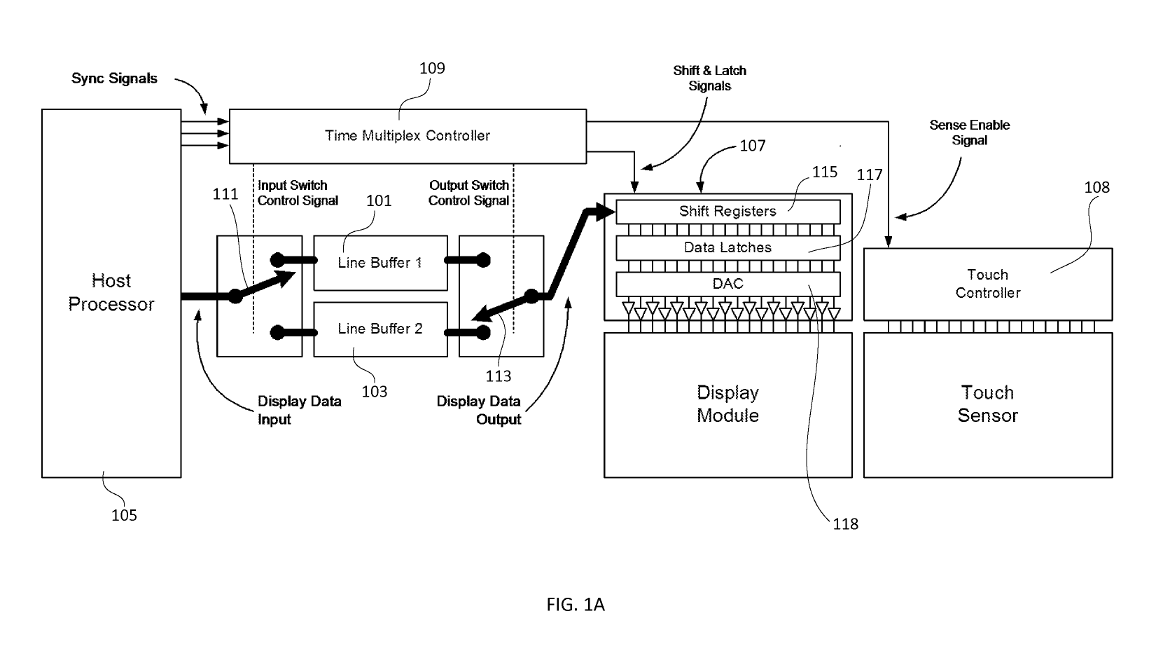

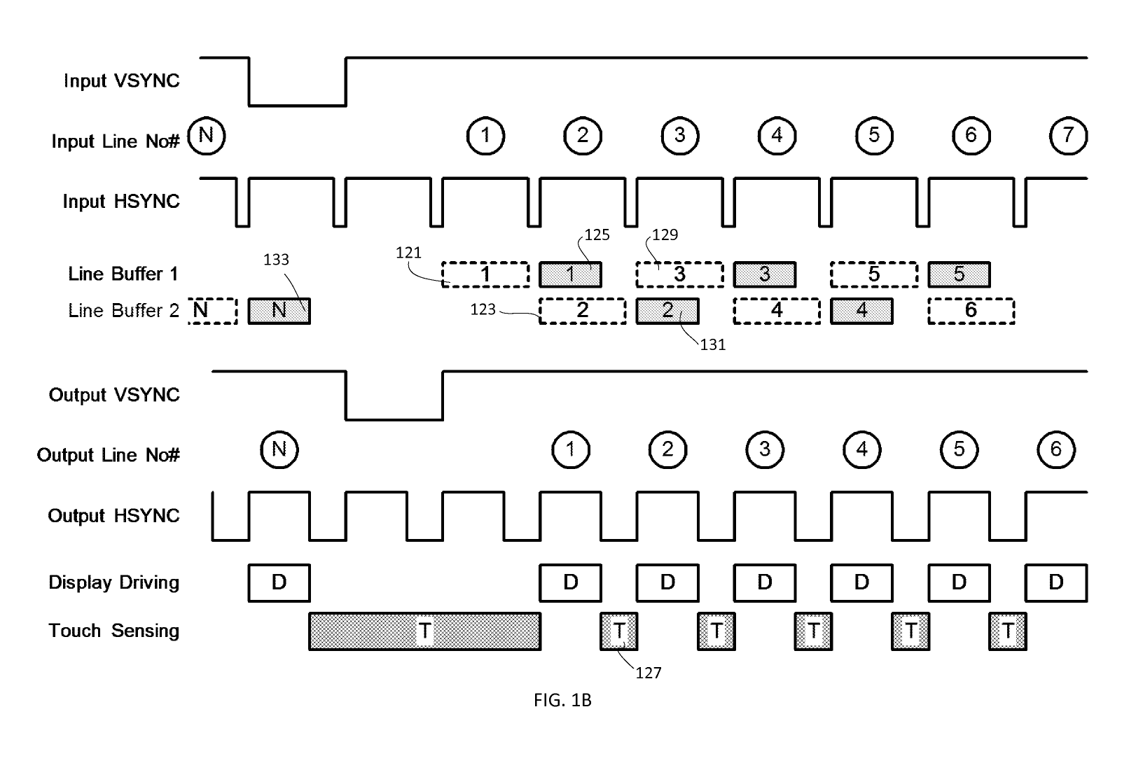

FIG. 1A illustrates an apparatus for driving an in-cell touch display panel in accordance with an embodiment of the present patent application. Referring to FIG. 1A, two line buffers 101 and 103 are positioned in-between a host processor 105 and a display driver 107. The line buffers are single port buffers. READ access and WRITE access have to be done separately (i.e. cannot be done simultaneously). A time multiplex controller 109 regulates the input and output of the display data. The output data rate is faster than the input data rates so that a certain amount of time can be saved. The saved time slot will be used for touch sensing. The apparatus further includes an input data switch 111 configured to direct display data from the host processor to either line buffer 1 or line buffer 2, and an output data switch 113 configured to direct display data either from line buffer 1 or line buffer 2 to the display driver 107.

Referring to FIG. 1A, the display driver 107 includes a sequence of shift registers 115, a sequence of data latches 117 connected in parallel with the shift registers 115, and a plurality of DACs 118 connected in parallel with the data latches 117.

The display driver 107 is configured to collect display data from the line buffers at a fast rate through the sequence of shift registers 115. Once a whole line of display data are collected (through the shift registers), display data are transferred to the sequence of data latches 117 instantaneously. This process allows simultaneous digital-to-analog conversion (through the DACs 118) and simultaneous driving of the analog signals to the display modules. The time multiplex controller 109 is also configured to organize and signal the time slots for the touch controller 108 to carry out touch sensing.

FIG. 1B is a timing diagram illustrating a method for driving an in-cell touch display panel in accordance with an embodiment of the present patent application. Referring to FIG. 1B, the host processor 105 generates a 1st line display data at its regular data rate. The time multiplex controller 109 uses the line buffer 1, i.e. the line buffer 101, which is an empty buffer at this stage, to store the display data received from the host processor 105 (time slot 121). The host processor 105 then generates a 2nd line display data after the 1st line display data (time slot 123). The time multiplex controller 109 controls line buffer 2, i.e. the line buffer 103, which is also empty at this stage, to store the display data from the host processor 105 (time slot 123). At the same time, the 1st line display data in the line buffer 1 is being transferred to the display driver 107 at a faster rate (time slot 125). Since the display driver 107 completes driving the 1st line signal before the 2nd line display data collection, the saved time slot 127 is used for touch sensing. Then, the time multiplex controller 109 controls the line buffer 1 to store a 3rd line display data from the host processor (time slot 129). Concurrently, the 2nd line display data in the line buffer 2 is being transferred to the display driver 107 at a faster rate (time slot 131).

This process is carried on until the end of the frame (time slot 133). Since this line buffering process will generate a one line period delay between input and output, the time multiplex controller 109 will regenerate a delay version of the VSYNC (vertical sync) signal for the display driver, referring to the signal Output VSYNC as illustrated in FIG. 1B. In addition, since the touch controller 108 can use the HSYNC (horizontal sync) signal as touch enable signal, the time multiplex controller 109 also alters the mark-space ratio of the HSYNC signal, referring to the signal Output HSYNC as illustrated in FIG. 1B.

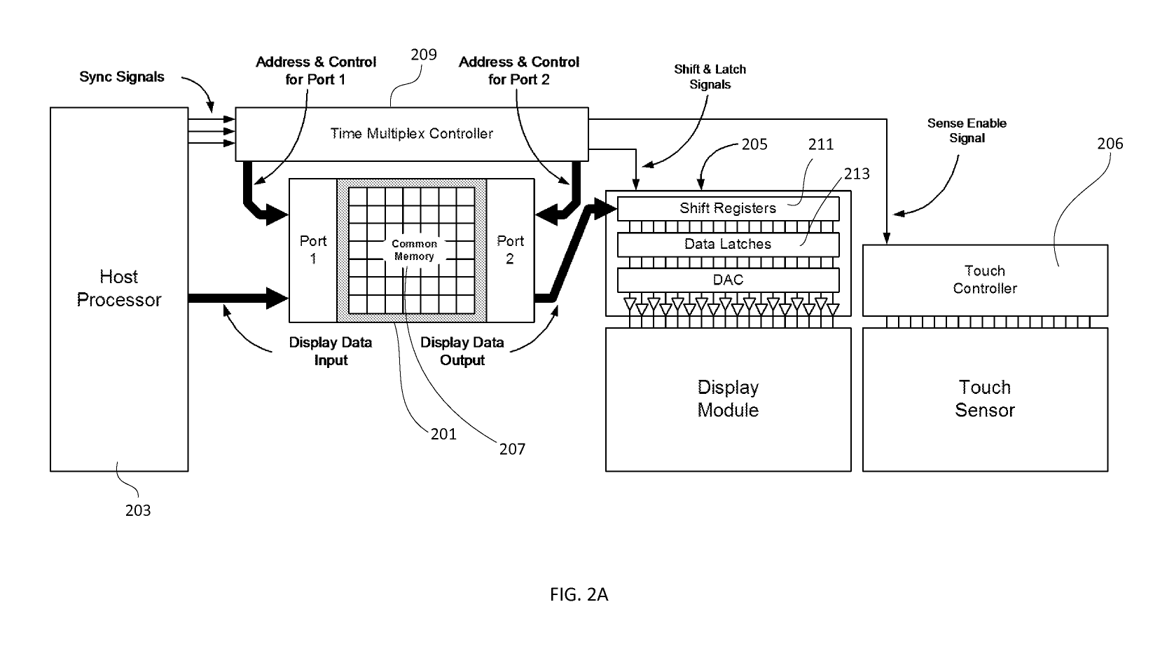

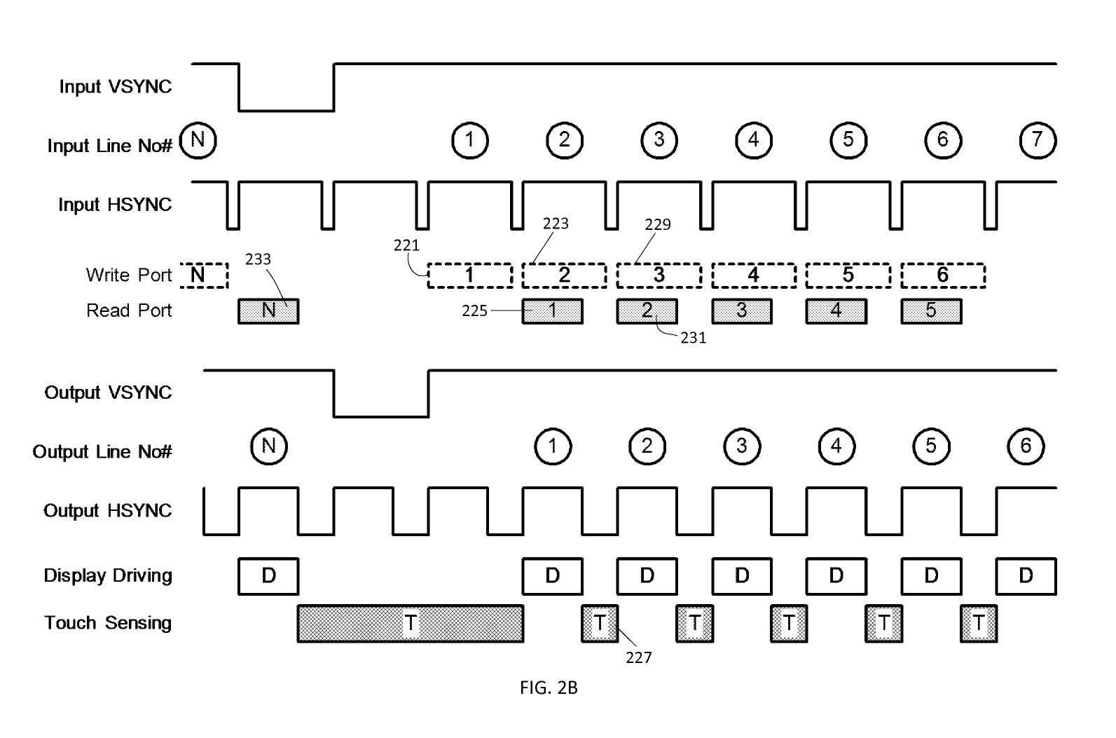

FIG. 2A illustrates an apparatus for driving an in-cell touch display panel in accordance with another embodiment of the present patent application. Referring to FIG. 2A, a dual port buffer 201 is positioned in-between a host processor 203 and a display driver 205. The dual port buffer 201 is configured to access any two memory locations at the same time. Hence, one READ access and one WRITE access can be done simultaneously. The dual port buffer 201 includes a common memory 207 inside. The common memory 207 is configured to store two lines of display data. A time multiplex controller 209 regulates the input and output of the display data. The output data rate is faster than the input data rate so that certain amount of time can be saved. The saved time slot will be used for touch sensing. The common memory includes a first region and a second region. Each region is configured for one line display data storage.

By controlling the address of port 1, display data from the host processor 203 can be stored to a region of a common memory 207. By controlling the address of port 2, display data from a region of the common memory 207 can be retrieved and sent to the display driver 205.

The display driver 205 is configured to collect display data from the dual port buffer 201 at a fast rate through a sequence of shift registers 211. Once a whole line of display data are collected (through the shift registers 211), display data are transferred to a sequence of data latches 213 instantaneously. This process allows simultaneous digital-to-analog conversion and the simultaneous driving of the analog signals to the display modules. The time multiplex controller 209 is also configured to organize and signal the time slots for the touch controller to carry out touch sensing.

FIG. 2B is a timing diagram illustrating a method for driving an in-cell touch display panel in accordance with another embodiment of the present patent application. Referring to FIG. 2B, the host processor 203 generates a 1st line display data at its regular data rate. The time multiplex controller 209 controls the first region to store the display data from the host processor 203 (time slot 221). The host processor 205 then generates a 2nd line display data after the 1st line display data (time slot 223). The time multiplex controller 209 controls the second region of the common memory 207 to store the display data from the host processor 203. At the same time, the 1st line display data in the first region of the common memory 207 is being transferred to the display driver 205 at a faster rate (time slot 225). Since the display driver 205 completes driving the 1st line signals before the 2nd line display data collection, the saved time slot 227 is used for touch sensing. The time multiplex controller 209 controls the first region of the common memory 207 to store a 3rd line display data from the host processor 203 (time slot 229), since the previous display data have been transferred to the display driver 205 already. Concurrently, the 2nd line display data in the second region of the common memory 207 is being transferred to the display driver 205 at a faster rate (time slot 231).

This process is carried on until the end of the frame (time slot 233). Since this line buffering process will generate a one line period delay between the input and the output, the time multiplex controller 209 will regenerate a delay version of the VSYNC (vertical sync) signal for the display driver 205, referring to the signal Output VSYNC in FIG. 1B. In addition, since the touch controller 206 can use the HSYNC (horizontal sync) signal as a touch enable signal, the time multiplex controller 209 also alters the mark-space ratio of the HSYNC signal, referring to the signal Output HSYNC in FIG. 2B.

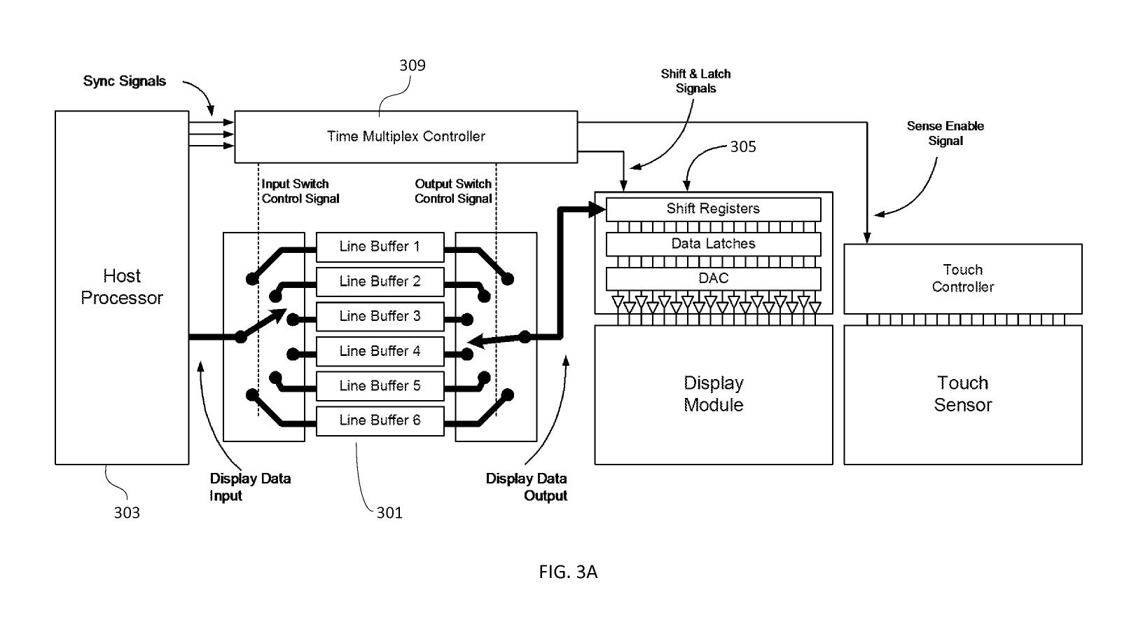

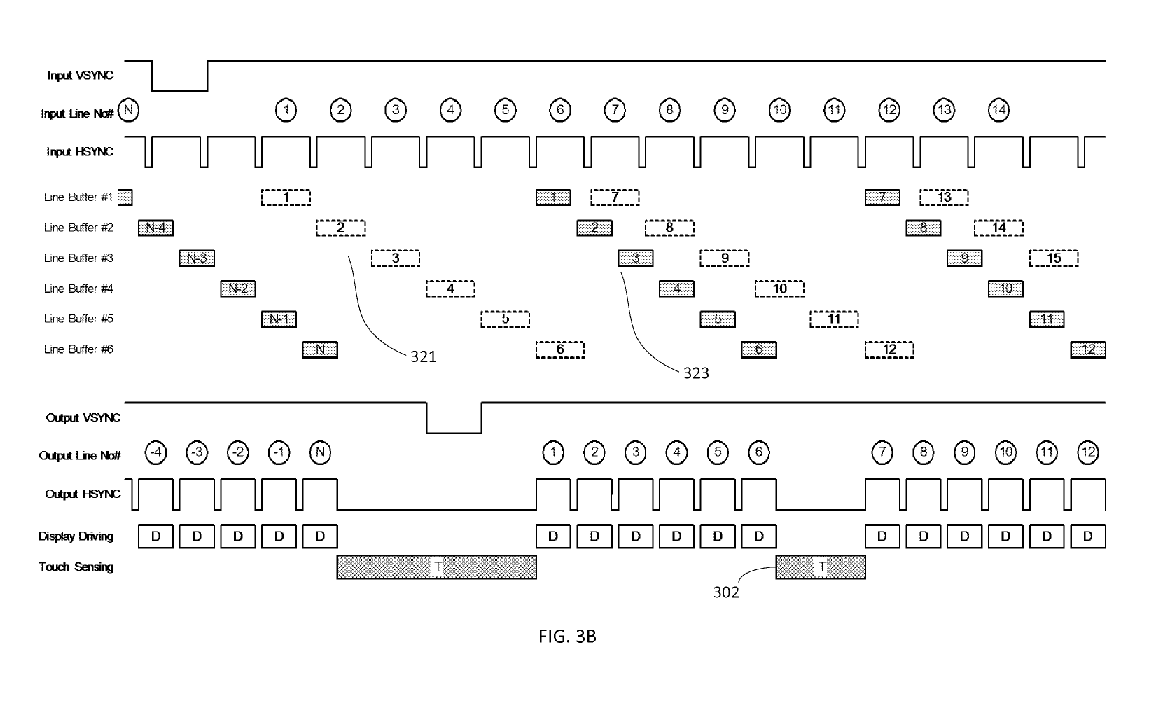

FIG. 3A illustrates an apparatus for driving an in-cell touch display panel in accordance with yet another embodiment of the present patent application. Referring to FIG. 3A, longer display and touch time multiplexing is implemented by using more than two single port line buffers. Although it is desirable to spread the touch sensing time within one frame time, each touch sensing period should not be too short. Otherwise, the touch sensing cannot be done properly and performance will be degraded. By using more line buffers, a better display driving and touch sensing multiplexing scheme can be accomplished. In this embodiment, each segment has 6 lines.

FIG. 3B is a timing diagram illustrating a method for driving an in-cell touch display panel in accordance with yet another embodiment of the present patent application. Referring to FIG. 3A and FIG. 3B, the dotted squares 321 refer to time slots when the time multiplex controller 309 controls the various line buffers to store the display data from the host processor 303. The solid squares 323 refer to time slots when line display data in the various buffers is being transferred to the display driver 305 at a faster rate.

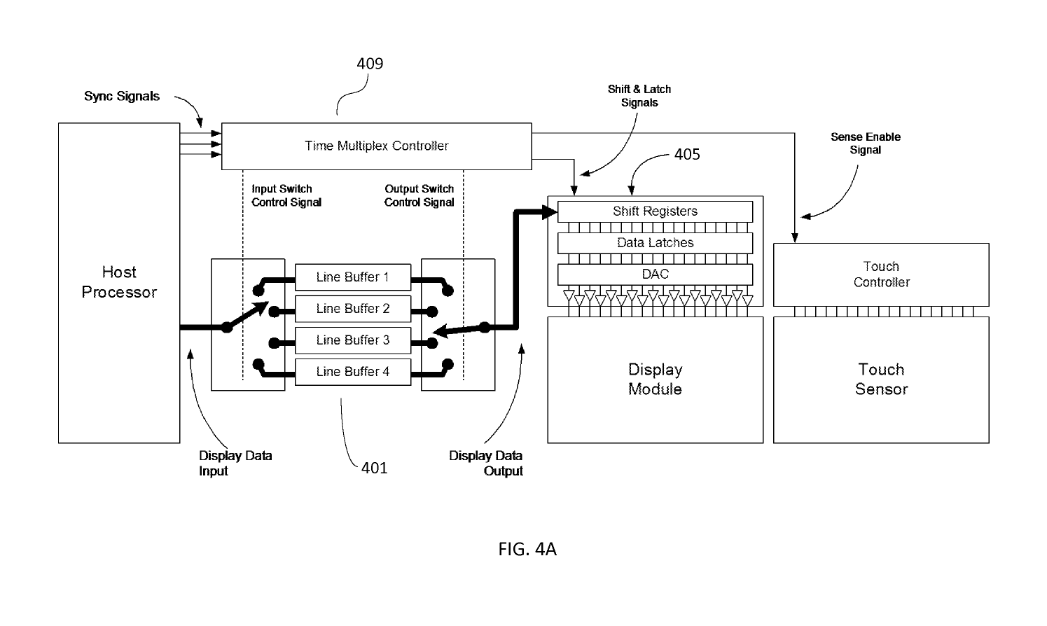

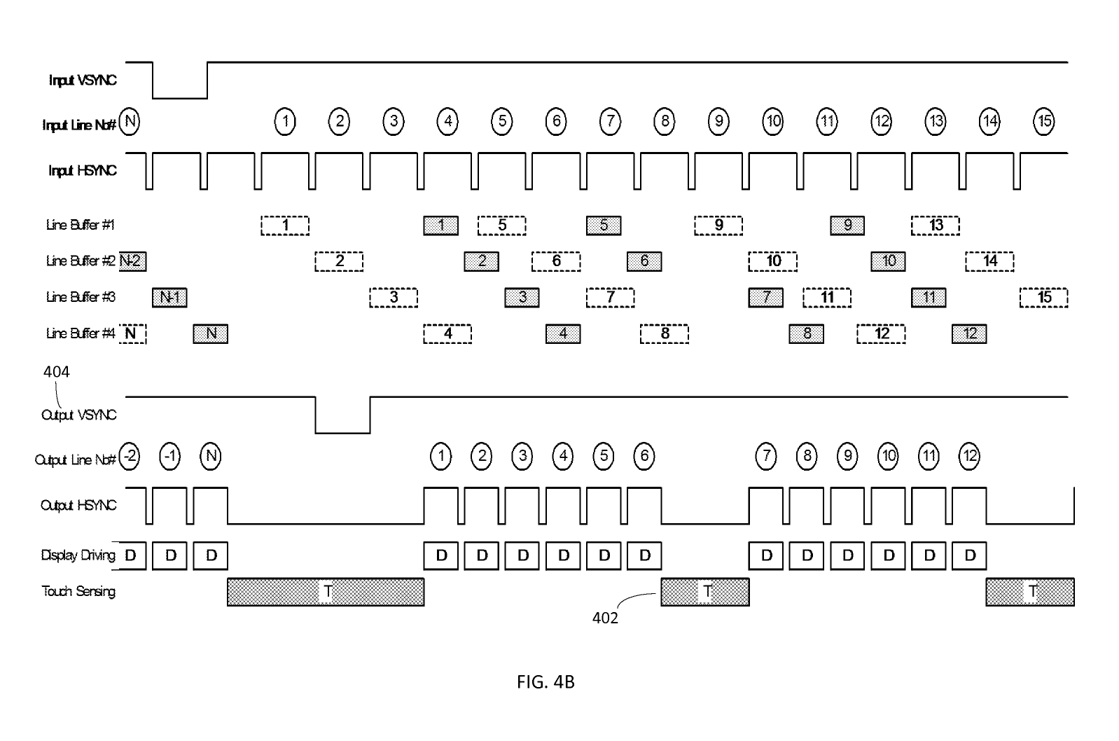

FIG. 4A illustrates an apparatus for driving an in-cell touch display panel in accordance with still another embodiment of the present patent application. FIG. 4B is a timing diagram illustrating a method for driving an in-cell touch display panel in accordance with still another embodiment of the present patent application. Referring to FIG. 4A and FIG. 4B, longer display and touch time multiplexing is implemented by more efficient line buffer usage. Line buffer occupies a large area in a display driver. When the size of the segment grows, generally more line buffers are required and the cost will be higher. In this embodiment, smaller amount of line buffers can be used to achieve the same result. In each segment, the display driver is configured to start to output the received data before the end of the segment. In other words, the time multiplex controller is configured to control the line buffers to start to output received display data of a data segment before fully receiving all of the data segment. This helps to reduce the amount of line buffers.

When comparing the embodiments illustrated by FIG. 3A and FIG. 4A, the embodiment in FIG. 4A is 2 line buffers less than the embodiment in FIG. 3A. The memory size of the 4 line buffer 401 in FIG. 4A is around 66% of that of the full 6 line buffer 301 in FIG. 3A.

When comparing the embodiments illustrated by FIG. 3B and FIG. 4B, the duration of the saved time slots, indicated as gray boxes ‘T’ (302 in FIG. 3B and 402 in FIG. 4B), that can be used for touch sensing are the same. This is because, in both cases, 6 lines of display data are being transferred to the display driver per segment so the saved time slots are the same.

Since this line buffering process will generate a 3-line period delay between the input and the output, the time multiplex controller 409 will regenerate a delayed version of the VSYNC (vertical sync) signal for the display driver 405 (referring to Output VSYNC 404 in FIG. 4B).

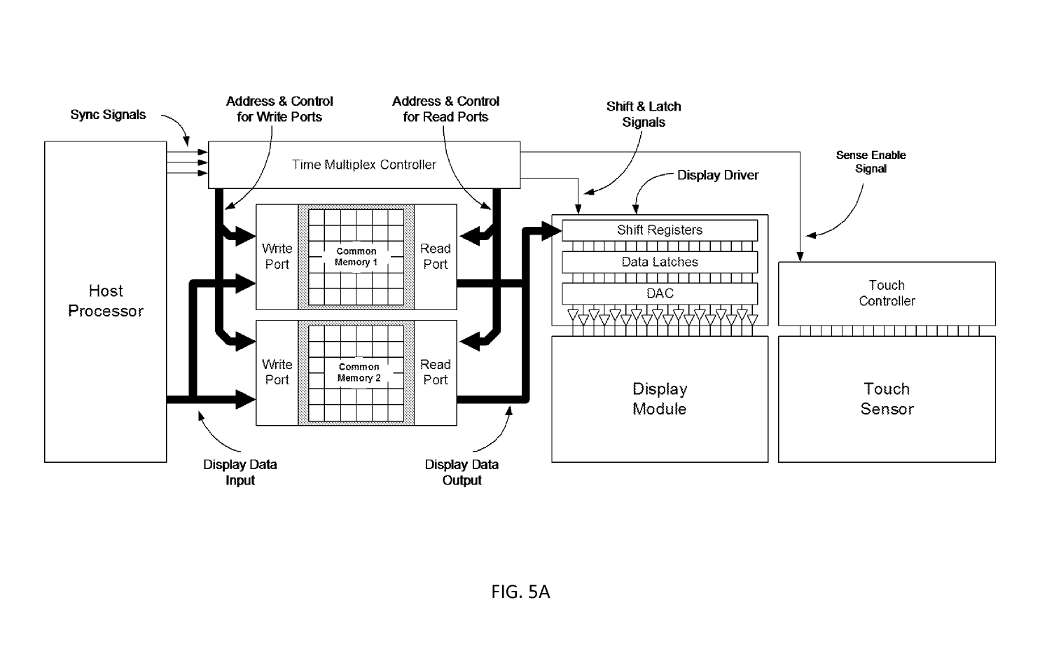

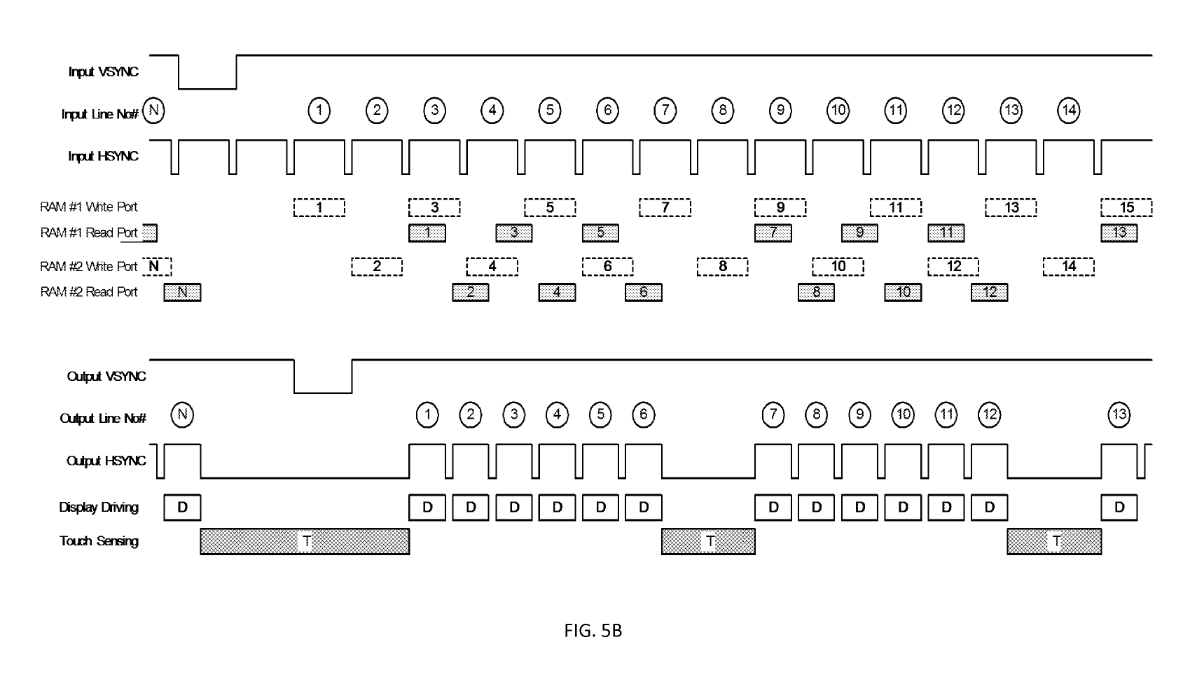

FIG. 5A illustrates an apparatus for driving an in-cell touch display panel in accordance with still another embodiment of the present patent application. FIG. 5B is a timing diagram illustrating a method for driving an in-cell touch display panel in accordance with still another embodiment of the present patent application. Referring to FIG. 5A and FIG. 5B, longer display and touch time multiplexing is implemented by using more than one dual port line buffer. Similar to the embodiment illustrated by FIG. 4A and FIG. 4B, it is also possible to implement the longer time multiplexing scheme with dual port line buffers. In this embodiment, by the interleaving of dual port line buffers, only two dual port line buffers are needed to support 6 lines per segment display-touch multiplexing. The memory size is around 50% of a full 6 line buffer.

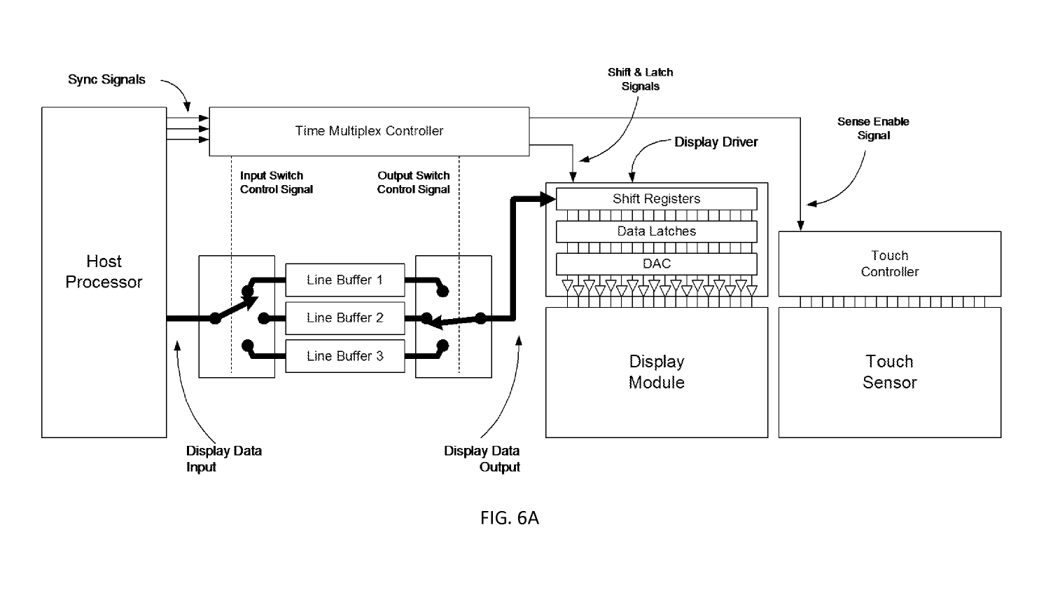

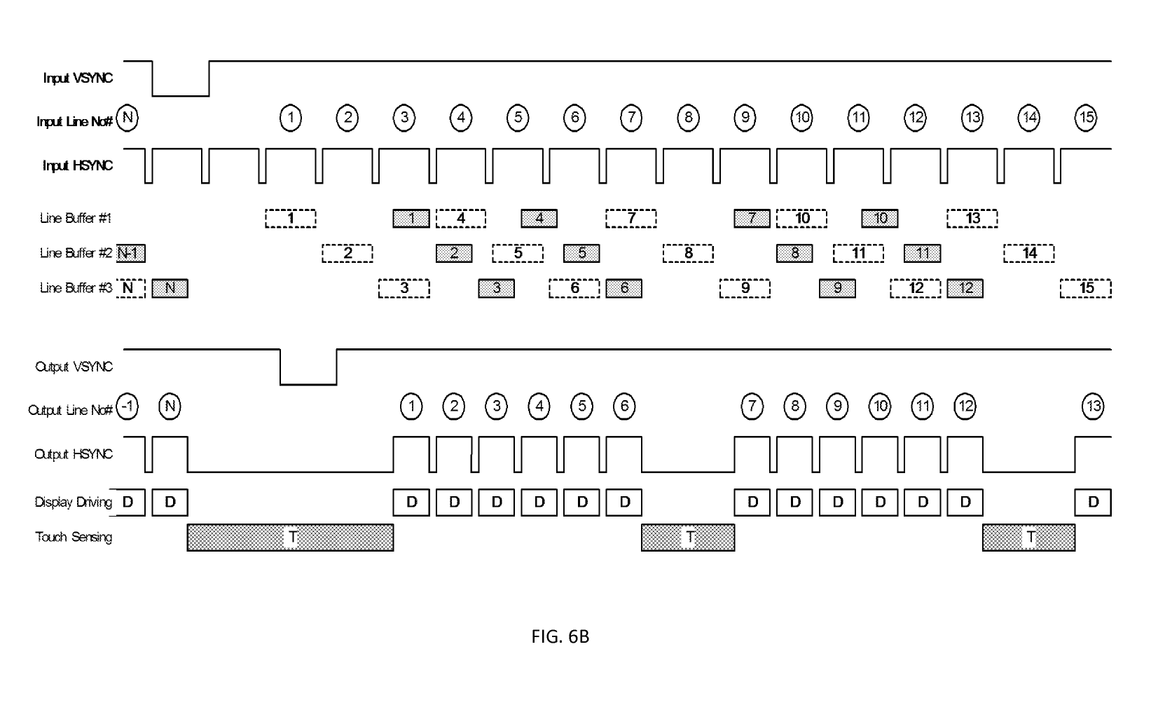

FIG. 6A illustrates an apparatus for driving an in-cell touch display panel in accordance with still another embodiment of the present patent application. FIG. 6B is a timing diagram illustrating a method for driving an in-cell touch display panel in accordance with still another embodiment of the present patent application. Referring to FIG. 6A and FIG. 6B, longer display and touch time multiplexing is implemented by optimal line buffer usage. In this embodiment, one line buffer is added and the dual port line buffer is changed into single port. Since the size of dual port line buffer is almost double the size of single port line buffer, this can reduce the overall cost. The memory size is also around 50% of that of a full 6 line buffer.

It is noted that by smart utilization of line buffers, the embodiment in FIG. 6A uses one less line buffer than the embodiment in FIG. 4A. This indicates that there can be many possible implementations and embodiments that smart multiplexing in time domain can achieve.

While the present patent application has been shown and described with particular references to a number of embodiments thereof, it should be noted that various other changes or modifications may be made without departing from the scope of the present invention.

What is claimed is:

1. An apparatus for driving an in-cell touch display panel, the apparatus comprising:
at least one line buffer configured to store display data;
a display driver configured to receive display data from the at least one line buffer and drive a display module based on the display data;
a touch controller configured to control a touch sensor to sense touching from a user;
a time multiplex controller connected with the at least one line buffer, the display driver and the touch controller; and
a host processor connected with the time multiplex controller and the at least one line buffer, and configured to generate display data and send the display data to the at least one line buffer;
wherein:
the time multiplex controller is configured to regulate output rate of the display data from the at least one line buffer to be faster than input rate of the display data to the at least one line buffer so that certain amount of time is saved, and to control the touch controller to execute touch sensing with the saved time.

2. The apparatus for driving in-cell touch display panel of claim 1 comprising two line buffers, wherein the line buffers are single port buffers, to which a read access and a write access need to be done separately.

3. The apparatus for driving in-cell touch display panel of claim 2 further comprising an input data switch configured to direct display data from the host processor to either one of the line buffers, and an output data switch configured to direct display data from either one of the line buffers to the display driver.

4. The apparatus for driving in-cell touch display panel of claim 2, wherein while controlling one line buffer to store display data from the host processor, the time multiplex controller is configured to transfer display data previously stored in the other line buffer to the display driver at a faster rate.

5. The apparatus for driving in-cell touch display panel of claim 1, wherein the display driver comprises a sequence of shift registers, a sequence of data latches connected in parallel with the shift registers, and a plurality of DACs connected in parallel with the data latches.

6. The apparatus for driving in-cell touch display panel of claim 1, wherein the line buffer is a dual port buffer configured to access any two memory locations simultaneously.

7. The apparatus for driving in-cell touch display panel of claim 6, wherein the line buffer further comprises a common memory configured to store two lines of display data in two regions thereof separately.

8. The apparatus for driving in-cell touch display panel of claim 6, wherein while controlling one region of the common memory to store display data from the host processor, the time multiplex controller is configured to transfer display data previously stored in the other region of the common memory to the display driver.

9. The apparatus for driving in-cell touch display panel of claim 1 comprising more than two line buffers, wherein the line buffers are single port buffers.

10. The apparatus for driving in-cell touch display panel of claim 1, wherein the time multiplex controller is configured to control the at least one line buffer to start to output received display data of a data segment before all of the data segment is fully received by the at least one line buffer.

11. The apparatus for driving in-cell touch display panel of claim 1 comprising two or more line buffers, wherein the line buffers are dual port buffers.

12. A method for driving an in-cell touch display panel, the method comprising:
generating display data and sending the display data to at least one line buffer;
storing the display data with the at least one line buffer;
receiving display data from the at least one line buffer and driving a display module based on the display data with a display driver;
regulating output rate of the display data from the at least one line buffer to be faster than input rate of the display data to the at least one line buffer and thereby so that certain amount of time is saved with a time multiplex controller;
controlling a touch controller to execute touch sensing with the saved time with the time multiplex controller; and
controlling a touch sensor to sense touching from a user with the touch controller.

13. The method for driving an in-cell touch display panel of claim 12, wherein two line buffers are used and the two line buffers are single port buffers, to which a read access and a write access need to be done separately.

14. The method for driving an in-cell touch display panel of claim 13 further comprising while controlling one line buffer to store display data from a host processor with the time multiplex controller, transferring display data previously stored in the other line buffer to the display driver at a faster rate with the time multiplex controller.

15. The method for driving an in-cell touch display panel of claim 12, wherein the line buffer is a dual port buffer configured to access any two memory locations simultaneously.

16. The method for driving an in-cell touch display panel of claim 15, wherein the line buffer further comprises a common memory configured to store two lines of display data in two regions thereof separately.

17. The method for driving an in-cell touch display panel of claim 15 further comprising while controlling one region of the common memory to store display data from a host processor, transferring display data previously stored in the other region of the common memory to the display driver with the time multiplex controller.

18. The method for driving an in-cell touch display panel of claim 12, wherein more than two line buffers are used for single port buffers and two or more line buffers are used for dual port buffers.

19. An apparatus for driving an in-cell touch display panel, the apparatus comprising:
a plurality of line buffers configured to store display data;
a display driver configured to receive display data from the line buffers and drive a display module based on the display data;
a touch controller configured to control a touch sensor to sense touching from a user;
a time multiplex controller connected with the line buffers, the display driver and the touch controller; and
a host processor connected with the time multiplex controller and the line buffers, and configured to generate display data and send the display data to the line buffers; wherein:
the time multiplex controller is configured to regulate output rate of the display data from the line buffers to be faster than input rate of the display data to the line buffers so that certain amount of time is saved, and to control the touch controller to execute touch sensing with the saved time; and
the time multiplex controller is further configured to control the line buffers to start to output received display data of a data segment before all of the data segment is fully received by the line buffers.

20. The apparatus for driving in-cell touch display panel of claim 19, wherein while controlling one line buffer to store display data from the host processor, the time multiplex controller is configured to transfer display data previously stored in another line buffer to the display driver at a faster rate.
